(19) United States
(12) Patent Application Publication
(10) Pub. No.: US 2020/0058910 A1
(43) Pub. Date: Feb. 20, 2020

(54) ADAPTER FOR BATTERY PACKS

(71) Applicant: BRIGGS & STRATTON CORPORATION, Wauwatosa, WI (US)

(72) Inventors: Brian Poirier, Wauwatosa, WI (US); Steve Curty, Wauwatosa, WI (US); Robert Koenen, Wauwatosa, WI (US)

(73) Assignee: BRIGGS & STRATTON CORPORATION, Wauwatosa, WI (US)

(21) Appl. No.: 16/542,778

(22) Filed: Aug. 16, 2019

Related U.S. Application Data
(60) Provisional application No. 62/765,002, filed on Aug. 17, 2018.

(51) Int. Cl. H01M 2/10; H01M 10/42; H01M 2/02; H02J 7/00; H01M 10/62; H01M 10/663

(52) U.S. Cl. CPC H01M 2/1077; H01M 10/4257; H01M 10/663; H02J 7/0065; H01M 10/62; H01M 2/0245

(57) ABSTRACT

A battery adapter assembly for engine-powered outdoor power equipment including a battery pack, an adapter, a receiver, and a starting motor. The battery pack includes multiple battery cells, a positive terminal, and a negative terminal and is removable and replaceable. The adapter is structured to selectively connect to the battery pack and electrically connect to the positive terminal and the negative terminal of the battery pack. The receiver is structured to selectively receive and electrically connect to the adapter to transfer power from the battery pack to the receiver. The starting motor is structured to start an internal combustion engine and selectively receives power supplied by the battery pack. The adapter is structured to connect to and transfer power from multiple battery packs having different voltages.

### CROSS-REFERENCE TO RELATED PATENT APPLICATIONS

This application claims the benefit of U.S. Provisional Application No. 62/765,002, filed Aug. 17, 2018, which is incorporated herein by reference in its entirety.

### BACKGROUND

The present invention generally relates to internal combustion engines including electric starting systems and outdoor power equipment powered by such engines.

Outdoor power equipment includes lawn mowers, riding tractors, snow throwers, pressure washers, portable generators, tillers, log splitters, zero-turn radius mowers, walk-behind mowers, riding mowers, industrial vehicles such as forklifts, utility vehicles, etc. Outdoor power equipment may, for example use an internal combustion engine to drive an implement, such as a rotary blade of a lawn mower, a pump of a pressure washer, the auger of a snow thrower, the alternator of a generator, and/or a drivetrain of the outdoor power equipment.

Various types of outdoor power equipment can include electric starting systems in which a starter motor powered by a battery starts the engine. Typically, such electric starting systems also include a user-actuated starter switch (e.g., a push-button, key switch) and a starter solenoid. The starter solenoid is the connection between a low current circuit including the starter switch and a high current circuit including the starter motor. To start the engine, the user actuates the starter switch, causing the starter solenoid to close so that the battery provides starting current to the starting motor to start the engine.

### SUMMARY

One embodiment of the invention relates to a battery adapter assembly for engine-powered outdoor power equipment. The battery adapter assembly includes a battery pack, an adapter, a receiver, and a starting motor. The battery pack includes multiple battery cells, a positive terminal, and a negative terminal and is removable and replaceable. The adapter is structured to selectively connect to the battery pack and electrically connect to the positive terminal and the negative terminal of the battery pack. The receiver is structured to selectively receive and electrically connect to the adapter to transfer power from the battery pack to the receiver. The starting motor is structured to start an internal combustion engine and selectively receives power supplied by the battery pack. The adapter is structured to connect to and transfer power from multiple battery packs having different voltages.

Another embodiment of the invention relates to an air-cooled engine system for outdoor power equipment. The air-cooled engine system includes an air-cooled engine having a piston reciprocating along a piston axis within a cylinder and structured to power an implement of the outdoor power equipment. The system further includes a starting system structured to start the air-cooled engine and includes a battery pack having multiple battery cells each positioned along a battery cell axis, an adapter structured to selectively connect to the battery pack and electrically connect to the positive terminal and the negative terminal of the battery pack, a receiver structured to selectively receive and electrically connect to the adapter to transfer power from the battery pack to the receiver, and a starting motor structured to start an internal combustion engine. The starting motor selectively receives power supplied by the battery pack. The adapter is structured to connect to a variety of battery packs with different connection and attaching interfaces and output a voltage to the receiver. The receiver receives the voltage from the adapter and outputs the voltage to the starting motor.

Another embodiment of the invention relates to a starting system for an outdoor power equipment. The starting system includes a starting motor structured to supply mechanical energy to an engine to start the engine, a receiver electrically connected to the starting motor and structured to selectively attach to and electrically connect to an adapter, and wherein the adapter is structured to selectively couple to and electrically connect to the receiver and a removable battery pack. The battery pack is at least one of a 12 volt, 14.4 volt, 18 volt, 20 volt, and 24 volt battery pack, and the adapter is structured to selectively couple to and electrically connect to a variety of battery connection types.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a diagram of a starting system, according to an exemplary embodiment.

FIG. 2 is a perspective view of the starting motor and the receiver of the starting system of FIG. 1.

FIG. 3 is a perspective view of the starting motor and the receiver of the starting system of FIG. 1.

FIG. 4 is a rear perspective view of the starting motor and the receiver of the starting system of FIG. 1.

FIG. 5 is a front perspective view of the adapter of FIG. 1.

FIG. 6 is a front perspective view of the adapter of FIG. 1.

FIG. 7 is a top perspective view of the adapter of FIG. 1.

FIG. 8 is a rear perspective view of the battery of FIG. 1.

FIG. 9 is a front perspective view of the battery and the adapter of FIG. 1.

FIG. 10 is a rear perspective view of the battery and the adapter of FIG. 1.

FIG. 11 is a side view of the battery and the adapter of FIG. 1.

FIG. 12 is a perspective view of the battery, adapter, receiver, and starting motor of FIG. 1.

FIG. 13 is a perspective view of the adapter and receiver of FIG. 1 assembled on a lawnmower.

FIG. 14 is a rear perspective view of the adapter and receiver of FIG. 1 assembled on a lawnmower.

FIG. 15 is a rear perspective view of the adapter and receiver of FIG. 1 assembled on a lawnmower.

FIG. 16 is a top view of the adapter and receiver of FIG. 1 assembled on a lawnmower.

FIG. 17 is a rear view of the adapter and receiver of FIG. 1 assembled on a lawnmower.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, an adapter system for batteries is shown. The adapter system may include a battery, an adapter, a receiver, and a starting motor. The adapter allows for a variety of different batteries (e.g., battery packs) to be electrically connected to various types of engines and outdoor power equipment. In some embodiments, the adapter is configured to selectively connect to different battery pack types or brands (different brands may have different connection interfaces) and different voltages of batteries. The adapter electrically connects to a receiver. The receiver is configured to electrically interface with the starting motor and the output of the adapter. In some embodiments the adapter and the receiver are integrally formed. The adapter may include a processing circuit configured to adjust the output voltage to the receiver based on the voltage of the battery and the required input voltage of the starting motor. For example, if the battery is a 12 volt battery and the starting motor requires 18 volts, the adapter (e.g., via processing circuit) may increase the voltage output to the receiver (and therefore also to the starting motor) to equal the voltage of the starting motor. In some embodiments, the voltage of the battery may be greater than the voltage of the starting motor. The processing circuit of the adapter may in this case reduce the voltage output from the adapter to equal the voltage required by the starting motor. In some embodiments, the processing circuit increases or decreases the output voltage of the output of the adapter using Pulse Width Modulation (PWM). In some embodiments, the battery is a power tool battery pack.

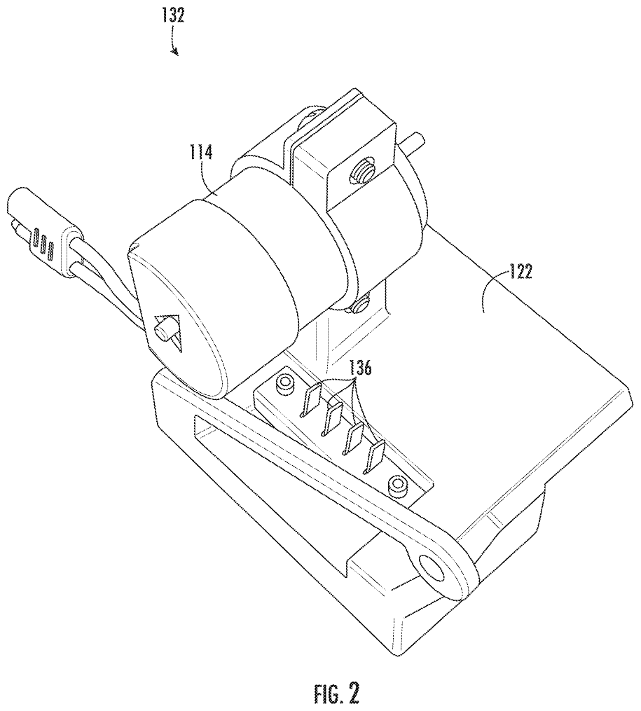

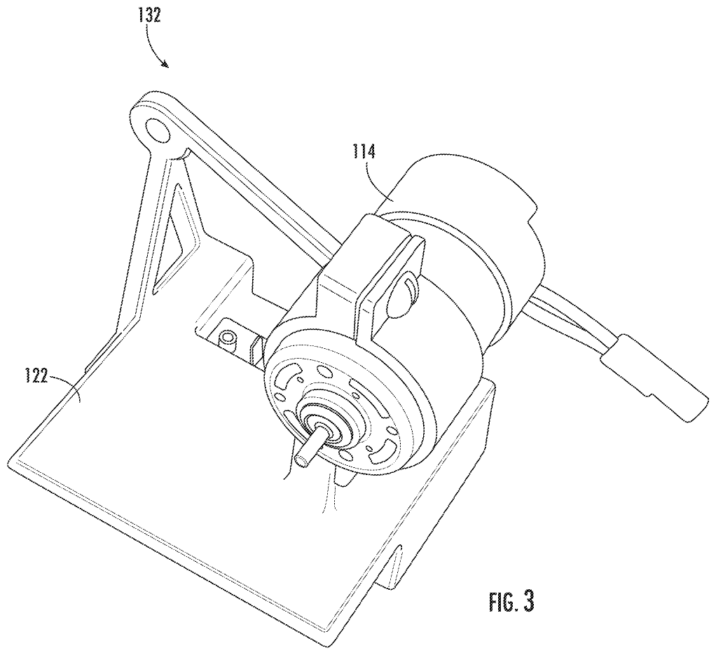

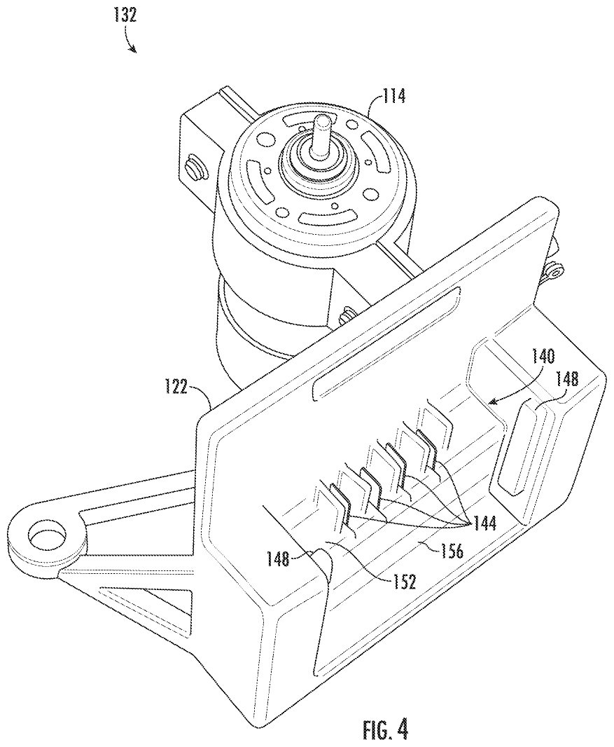

Referring now to FIGS. 2-4, a first assembly 132 of the starting motor 114 and the receiver 122 is shown according to some embodiments. The starting motor 114 is shown to be connected to the receiver 122, however in some embodiments, the starting motor 114 is not connected to the receiver 122 and, is instead, otherwise coupled to the engine 110. The receiver 122 is configured to transfer the energy supplied by the battery 128 to the starting motor 114 to start the engine 110. The receiver 122 includes male terminals 136. Male terminals 136 are configured to supply the starting motor 114 with energy from the battery 128 required to start the engine 110. In some embodiments, the male terminals 136 include a positive terminal, a negative terminal, an enabler terminal, a terminal configured to supply power to lights (not shown), a thermistor terminal, etc., or any other terminals necessary to power the starting motor 114, power accessories (not shown), or to provide additional safety features.

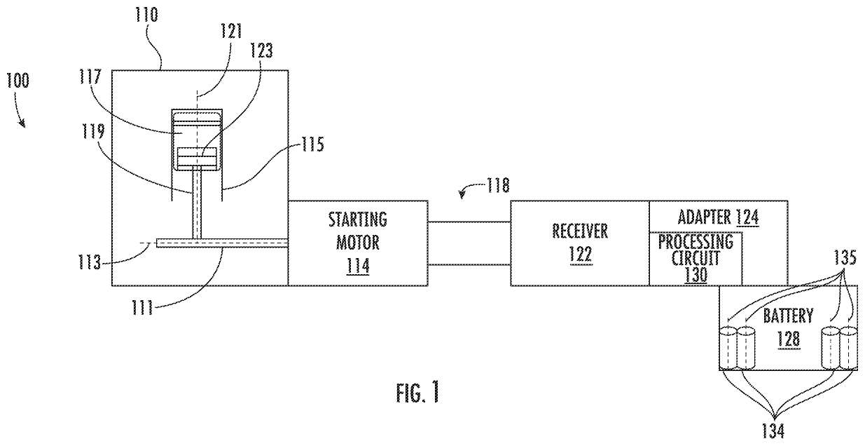

Referring to FIG. 1, a starting system 100 for outdoor power equipment is shown. The starting system includes an engine 110, a starting motor 114, a receiver 122 connected to the starting motor 114 through connections 118, an adapter 124, and a battery 128. Engine 110 includes a crankshaft 111 having a crankshaft axis 113, a piston 117 having a piston axis 121, a piston cylinder 115, and a connecting rod 119. The connecting rod 119 is rotatably coupled to piston 117 with wrist pin 123. Piston 117 travels along the piston axis within the piston cylinder 115. The adapter 124 is configured to interface with and selectively connect to the battery 128. Battery 128 may be a lithium-ion battery, a nickel cadmium battery, a zinc-carbon battery, etc., or any other battery used to store electrical energy. Battery 128 may be 12 volt, 14.4 volt, 18 volt, 20 volt, 24 volt, etc., or any other suitable voltages sufficient to power the starting motor 114. Battery 128 is shown to include a plurality of battery cells 134 having a battery axis 135. In some embodiments, battery 128 is a removable battery pack from a power tool. The adapter 124 is also configured to selectively attach to the starting motor 114 and to power the starting motor 114 with stored energy from the battery 128. In some embodiments, a user interface (not shown), such as a switch, a button, or a key-start is used to start the engine 110, with the starting motor 114 drawing power from the battery 128. The starting system 100 may be used on any outdoor power equipment which uses the engine 110. For example, the starting system 100 may be used to start the engine 110 of a lawn mower, a snow blower, a log splitter, a tiller, etc. In some embodiments, the engine 110 is an air cooled engine. The engine 110 may be a two-stroke engine, or a four-stroke engine in various embodiments.

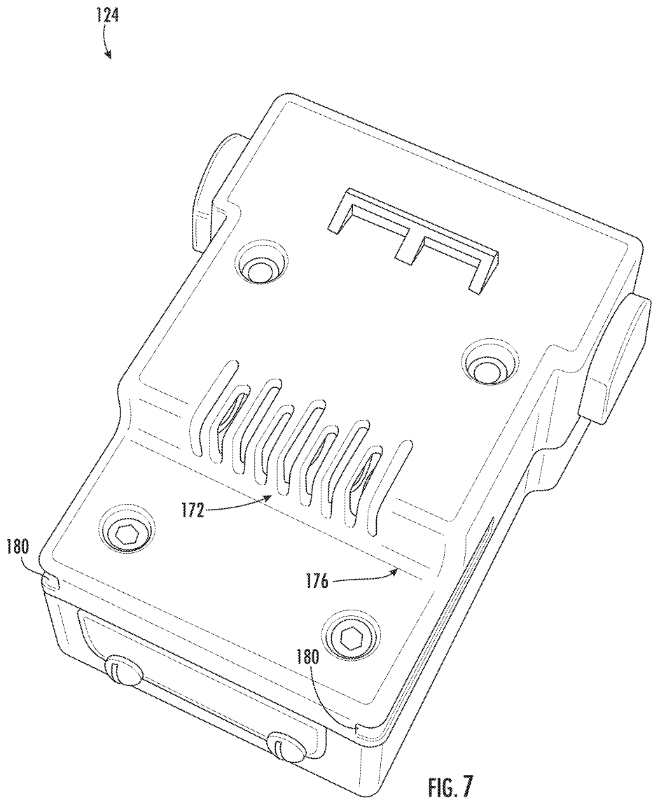

The receiver 122 may also include a recessed portion 140, configured to interface with and selectively couple with the adapter 124. The recessed portion 140 also includes male terminals 144 which are configured to connect to female terminals 720 (see FIG. 7) of the adapter 124 when the adapter 124 is connected to the receiver 122. Recessed portion 140 also includes a shoulder 156 and a shoulder 152 which are configured to interface with a shoulder 176 (see FIG. 7) of the adapter 124. Recessed portion 140 may also include guide rails 148 configured to act as a guide so that the adapter 124 connects properly to the receiver 122 when the adapter 124 is being attached to the receiver 122 by a user. In some embodiments, guide rails 148 also prevent the adapter 124 from disconnecting from the receiver 122 due to vibration from operation of the engine 110.

In some embodiments, the starting motor 114 is a 12 volt motor. In some embodiments, the starting motor 114 is an 18 volt motor. In some embodiments, the starting motor 114 is configured to provide a suitable speed and torque load to the engine 110 necessary to start the engine 110. The receiver 122 is configured to form a standard connection interface between the receiver 122 and the adapter 124, and to supply power to the starting motor 114 from the adapter 124. In some embodiments, receiver 122 and adapter 124 may be integrally formed.

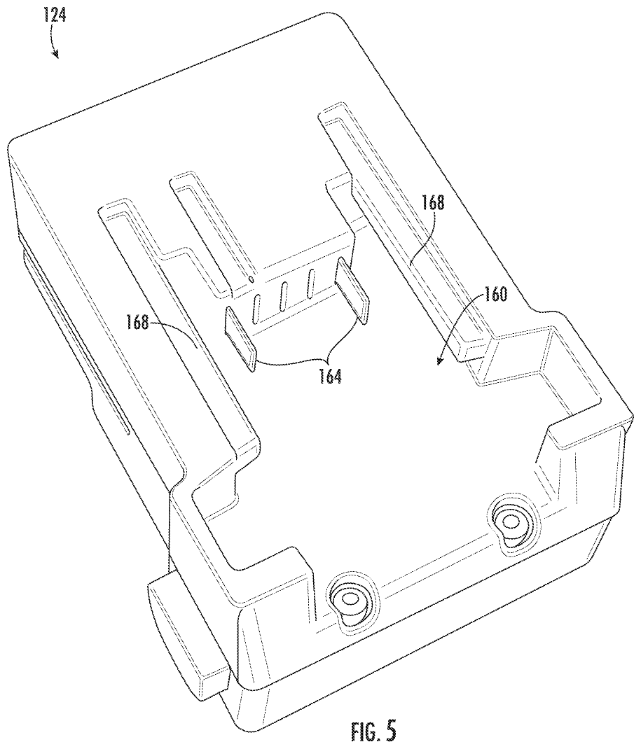

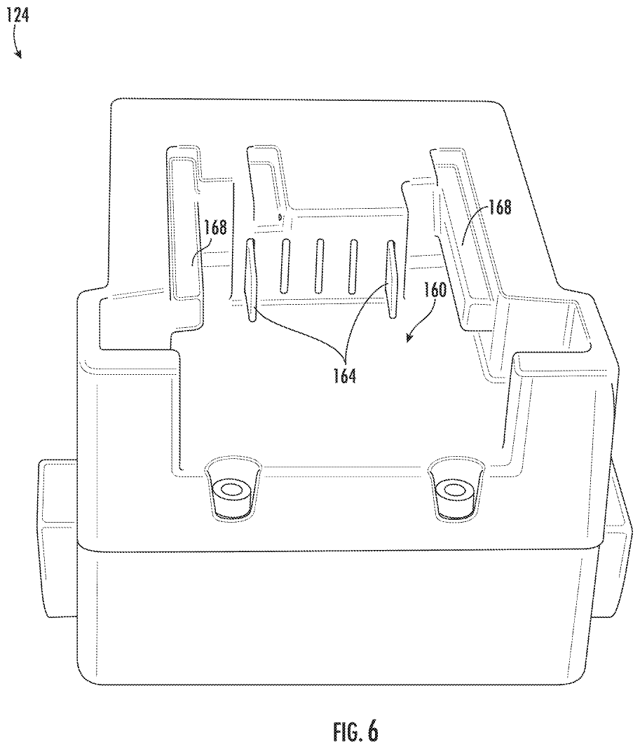

Referring now to FIGS. 5-7, the adapter 124 is shown. The adapter 124 includes a recessed portion 160 configured to allow the battery 128 to attach to the adapter 124. The recessed portion 160 includes terminals 164 configured to interface with a positive and negative terminal (not shown) of the battery 128 when connected. The recessed portion 160 further includes guide rails 168 configured to interface with a housing of the battery 128 and to guide the battery 128 to connect to the adapter 124 when the battery 128 is being connected. Furthermore, guide rails 168 may prevent the battery 128 from disconnecting from the adapter 124 during use.

The adapter 124 also includes female terminals 172 which are configured to interface with the terminals 410 of the receiver 122. The female terminals 172 may include the same terminals as terminals 144 of the receiver. In some embodiments, the adapter 124 also includes a shoulder 176 which is configured to interface with the shoulders 152 and 156 of the receiver. The adapter 124 also includes grooves 180 (shown in FIG. 7). Grooves 180 are configured to interface with guide rails 148 of the receiver 122 and stabilize the adapter 124 within the receiver 122 (e.g., limit movement of the adapter 124 within the receiver 122).

The adapter 124 is configured to transform the voltage supplied from the battery 128 to a different voltage which is suitable for the starting motor 114. In some embodiments, the battery 128 is an 18 volt battery while the starting motor 112 is a 12 volt motor. In this case, the adapter 124 is configured to transform the voltage from the battery to the required voltage of the starting motor 112. The adapter 124 may perform this by using a processing circuit 130 (shown in FIG. 1) configured to perform pulse width modulation (PWM) to supply the appropriate voltage to the starting motor 114 from the battery 128. In some embodiments, the voltage of the battery 128 is higher than the voltage of the starting motor 114 (e.g., the battery 128 is an 18 volt battery and the starting motor 114 is a 12 volt motor). In some embodiments, the voltage of the battery 128 is lower than the voltage of the starting motor 114 (e.g., the battery 128 is a 12 volt battery and the starting motor 114 is an 18 volt motor). The adapter 124 may either raise or lower the voltage transferred to the starting motor 114, depending on the voltage of the battery 128 (e.g., the adapter 124 uses PWM to raise the voltage from the 12 volt battery to match the 18 volt starting motor 114, or the adapter 124 uses PWM to lower the voltage from the 18 volt battery to match the 12 volt starting motor 114). In some embodiments, the battery 128 matches the starting motor 114 in voltage. In this embodiment, the adapter 124 does not raise or lower the voltage of the battery 128. In some embodiments, the adapter 124 raises or lowers the voltage using a step up transformer or a step down transformer.

In some embodiments, the adapter 124 varies in its connection configuration and terminal configuration according to the battery 128. For example, some batteries may vary in their terminal configuration and numbers, and another embodiment of the adapter 124 may be used configured to interface with the specific battery 128. However, the interface between the receiver 122 and the adapter 124 remains the same, with the same amount of terminals and the same connection configuration. Therefore, the adapter 124 may be configured to fit multiple types of batteries, or there may be multiple embodiments of the adapter 124 each configured to interface with a different battery 128 (or a set of batteries with similar connection interface) while still connecting to the receiver 122. In some embodiments, the adapter 124 is configured to interface with a predetermined set of multiple batteries 128, and includes a switch (not shown) to selectively choose between the batteries in the predetermined set. For example, the switch may be configured to select between several preset options of batteries 128. The position of the switch may adjust an operation of the processing circuit 130 to increase or decrease the voltage from the battery 128 supplied to the receiver 122. In some embodiments, the adapter 124 is selectively coupled to the receiver 122. In some embodiments, the adapter 124 and the receiver 122 are integrally formed. In some embodiments, the adapter 124 is configured to receive only one battery 128. In some embodiments, the adapter 124 is configured to receive more than one battery 128. The adapter 124 may also be configured to increase or decrease the voltage based on the starting motor 114 which is used.

In some embodiments, the adapter 124 includes safety features to ensure that the battery 128 does not damage itself or the adapter 124, the receiver 122, or the starting motor 114. The adapter 124 may include a load protector, which monitors the output voltage from the adapter 124 and ensures that an excessively high voltage is not supplied to the receiver 122 and thus the excessively high voltage is not supplied to the starting motor 114. In some embodiments, the load protector is part of the circuit configured to perform PWM. In some embodiments, the adapter 124 includes an enable terminal configured to enable or disable the operation of the processing circuit 130. Adapter 124 may also in some embodiments include a thermistor configured to detect the temperature of the battery 128. In some embodiments, the thermistor is part of the processing circuit 130 configured to perform PWM. In some embodiments, the processing circuit 130 is configured to monitor the performance of the battery 128 and the output of the adapter 124.

In some embodiments, the processing circuit 130 is configured to communicate information to a communications interface configured to output data to a display regarding the operation of the adapter 124 and the status of the battery 128. For example, the processing circuit 130 may output fault codes to the display. In some embodiments, the processing circuit 130 may output to the display low-current warnings or high-current warnings when an output current from the adapter 124 exceeds or falls below a set of current high/low threshold values. In some embodiments, the current high/low threshold values are determined by the starting motor 114. In some embodiments, the current high/low threshold values are determined by the battery 128. In some embodiments, the processing circuit 130 outputs information regarding the voltage to the display. In some embodiments, the information may indicate if the voltage across the positive and negative terminals of the output of the adapter 124 is too high, or if the voltage is too low. In some embodiments, the voltage information may indicate if the voltage supplied by the battery 128 is too high or too low compared to a set of voltage high/low threshold values determined by the battery 128 or starting motor 114 rating. In some embodiments, only the high current or voltage threshold value is used. In some embodiments, only the low current or voltage threshold value is used.

The adapter 124 may also include a fuse. The fuse may be configured as part of the processing circuit 130, or it may be configured to be separate from the processing circuit 130. In some embodiments, the fuse is configured to break when a current passing through the fuse exceeds or is below the set of current high/low threshold values. The current high/low threshold values may be determined by the rating of or operation of the starting motor 114, the battery 128, the receiver 122, or the adapter 124. In some embodiments, the fuse breaks and prevents current from passing to the starting motor 114 in order to prevent excessively high currents to be applied to the starting motor 114. In some embodiments, only the high current threshold value is used for this determination. In some embodiments, only the low current threshold value is used for this determination.

In some embodiments, the adapter 124 is water proof. Advantageously, this reduces the likelihood of water damage to the processing circuit 130 or to any other electrical components in the adapter 124. The adapter 124 may also include rubber dampers in order to decrease the vibration introduced to the adapter 124 when the engine 110 is in operation.

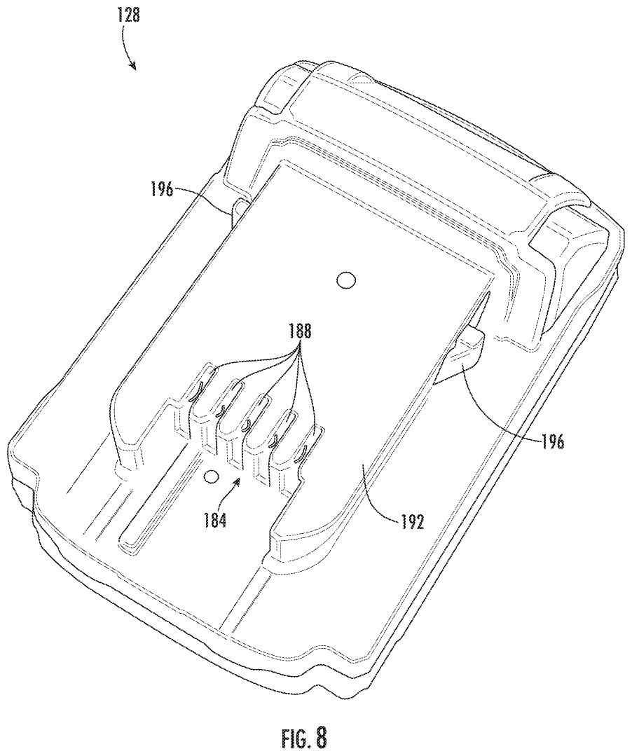

Referring now to FIG. 8, the battery 128 is shown, according to some embodiments. The battery 128 includes protrusion 192, connecting portion 184, terminals 188, and latch mechanism 196. The terminals 188 may include a positive terminal, a negative terminal, an enabler terminal, etc., or any other terminals. The protrusion 192 is configured to interface with the recessed portion 160 of the adapter 124. In some embodiments, the battery 128 does not include the connecting portion 184 and the protrusion 192. Latch mechanism 196 is configured to allow the battery 128 to be selectively connected to the adapter 124, ensuring that the battery 128 will not disconnect from the adapter 124 during use. In some embodiments, the battery 128 is a 12 volt battery. In other embodiments, the battery 128 may be a 14.4 volt, 18 volt, 20 volt, 24 volt battery, or any other voltage. In some embodiments, the battery 128 is a power tool battery.

In some embodiments, the battery 128 does not include a protrusion 192 or latch mechanism. In some embodiments, the battery 128 has a different connecting portion than the embodiment shown in FIG. 8. The adapter 124 may be configured to connect to the various embodiments of the battery 128.

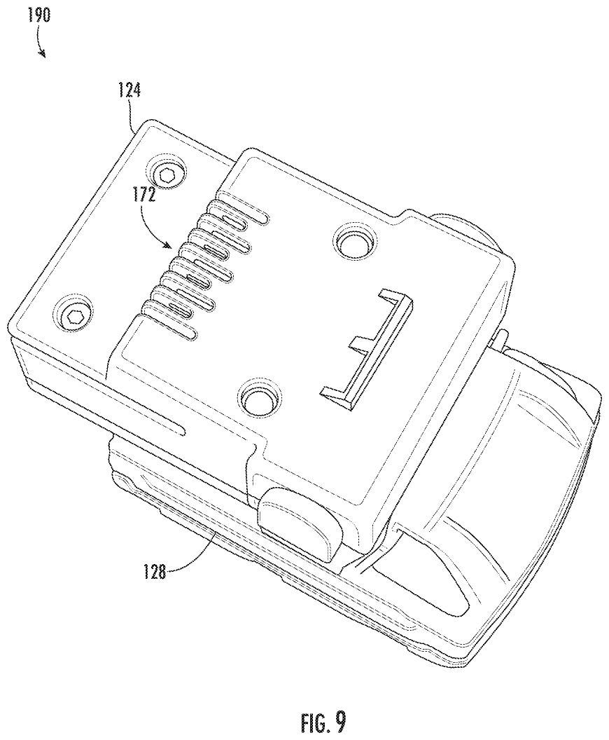

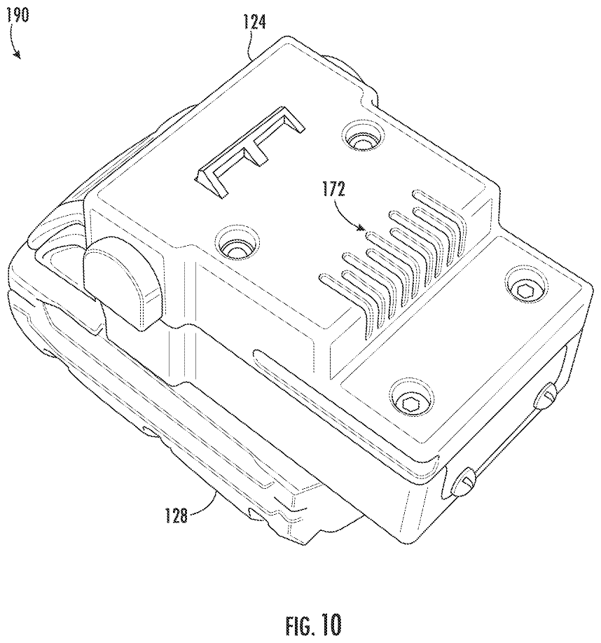

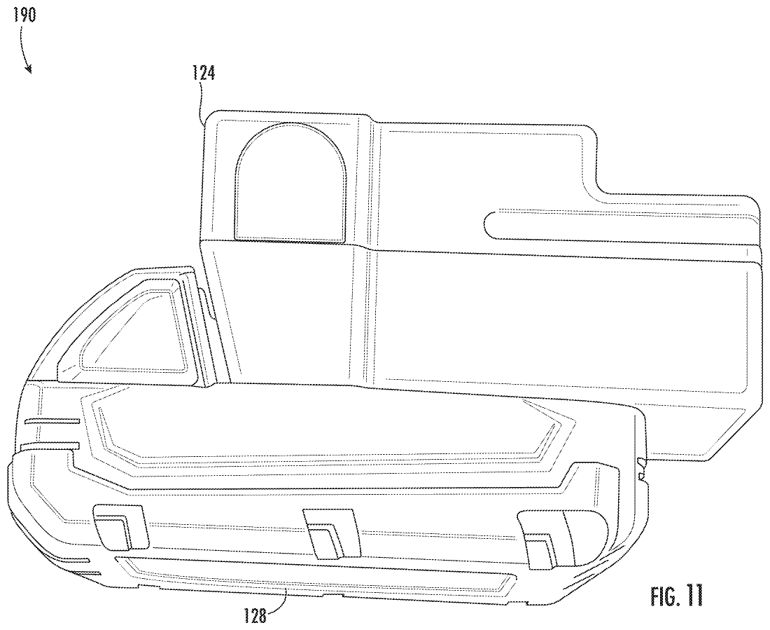

Referring now to FIGS. 9-11, a battery and adapter assembly 190 is shown according to some embodiments. The battery 128 is connected to the adapter 124, but the adapter 124 is not connected to the receiver 122. The female terminals 172 are shown according to some embodiments.

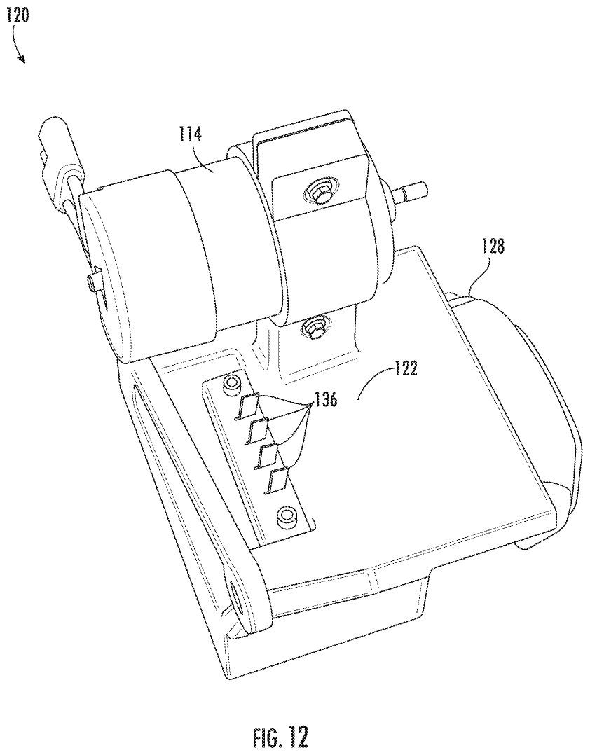

Referring now to FIG. 12, the starting motor assembly 120 is shown. The battery 128 is connected to the adapter 124 which is connected to the receiver 122. The starting motor assembly 120 is configured such that the energy from the battery 128 is transferred through the adapter 124, to the receiver 122, to the starting motor 114.

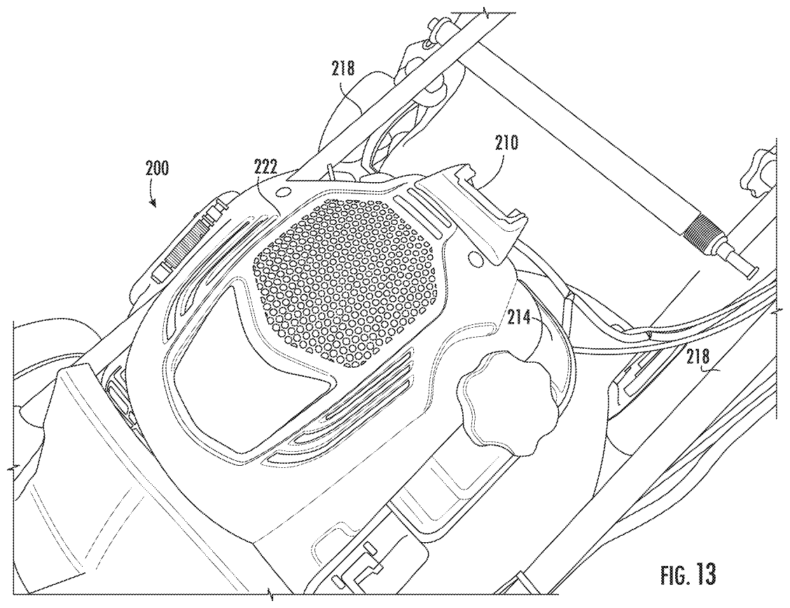

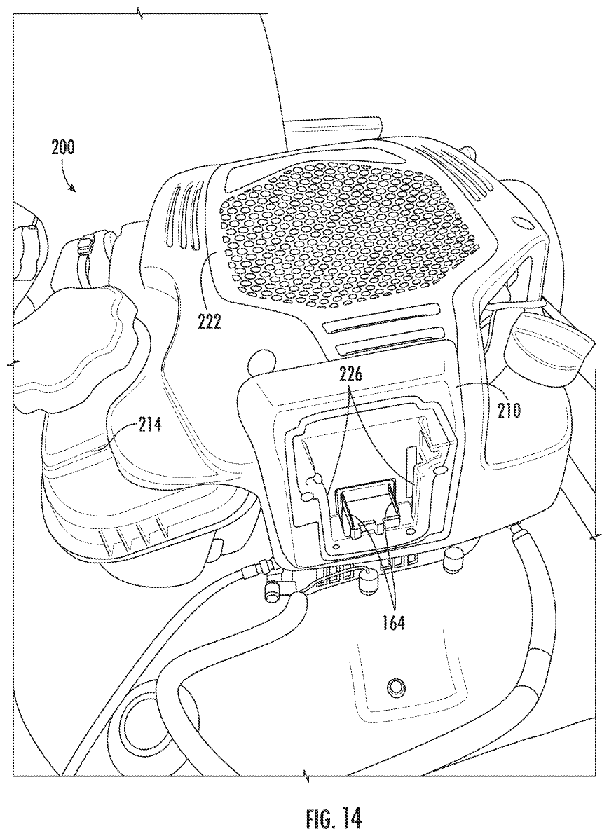

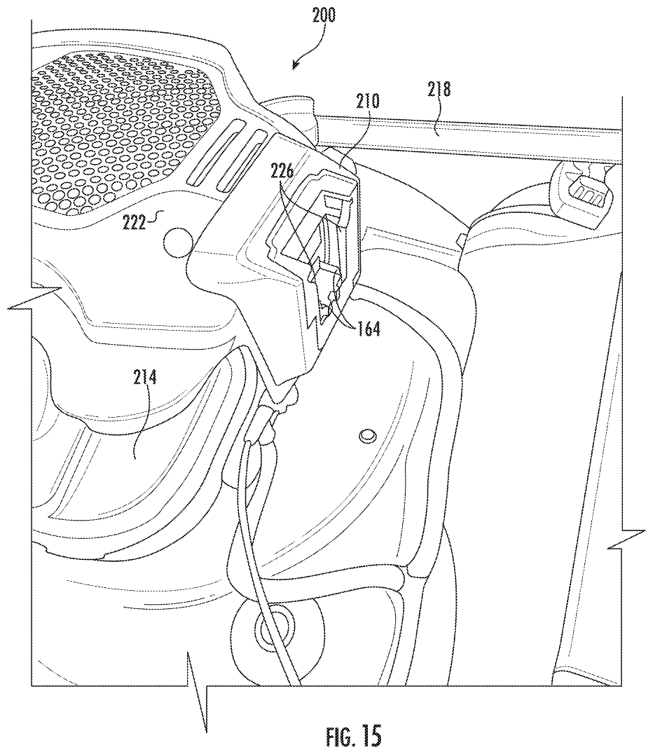

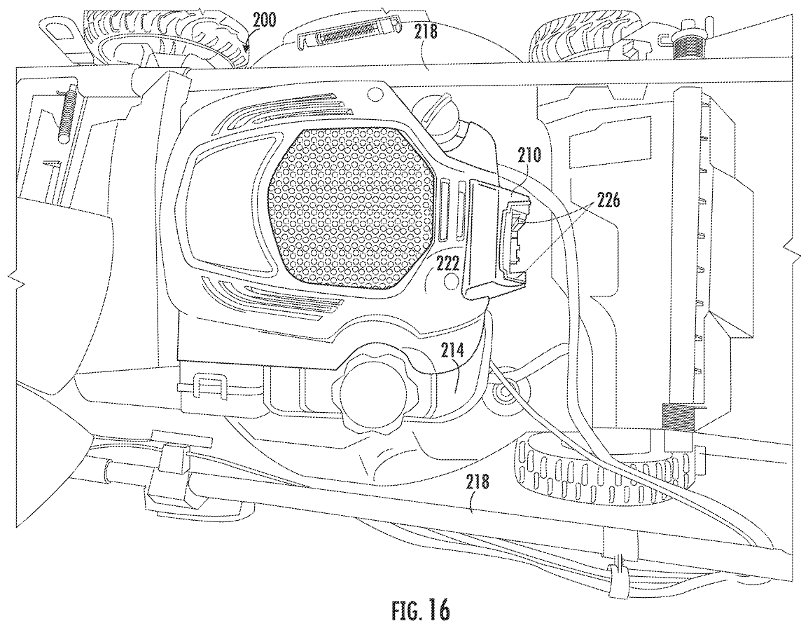

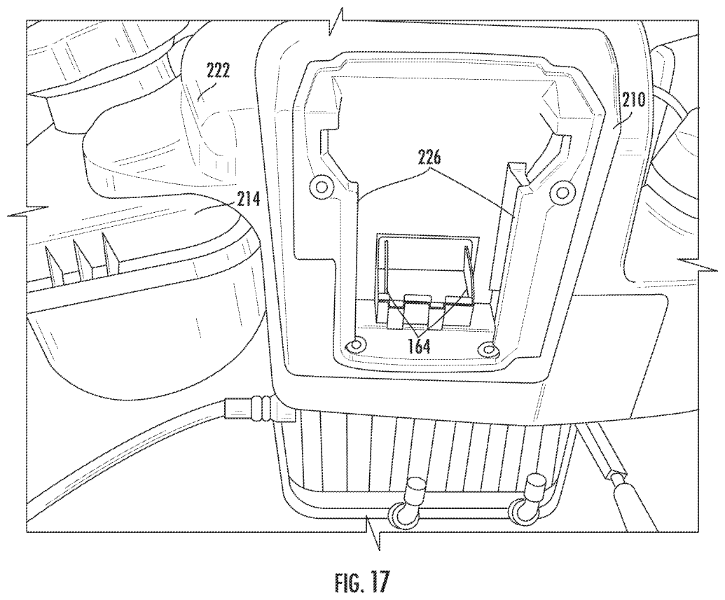

Referring now to FIGS. 13-17, the adapter 124 and receiver 122 are shown integrally formed as adapter assembly 210, installed on a walk-behind lawnmower 200 according to some embodiments. The walk-behind lawnmower 200 includes an engine housing 222, an engine (not shown) within engine housing 222, a fuel tank 214, and a starting motor (not shown) configured to provide mechanical energy required to start the engine. The adapter assembly 210 is attached to the engine housing 222 at a position that is at least partially rearward of the engine. The adapter assembly 210 is connected to the rear of the engine housing 222. The adapter assembly 210 is shown to be made of integrally formed adapter 124 and receiver 122. In some embodiments, the adapter 124 and the receiver 122 are not integrally formed, and the adapter 124 is selectively attached to the receiver 122 as discussed above. Adapter assembly 210 further includes guide rails 226 and terminals 164. In some embodiments, the adapter assembly 210 is connected to the engine housing 222 such that the guide rails 226 are vertically oriented. In some embodiments, the adapter assembly 210 is connected to the engine housing 222 such that the guide rails 226 are horizontally oriented. In some embodiments, the adapter assembly 210 is connected to the engine housing 222 such that the guide rails 226 are neither horizontally nor vertically oriented, but such that the guide rails 226 are oriented at an angle.

The adapter assembly 210 may be attached to the engine housing 222. In some embodiments, the adapter assembly 210 may attach directly to the engine or to a part of the engine (e.g., the engine block). Adapter assembly 210 may attach to the engine housing 222 at a position that is in front of, or to the side of the engine. In some embodiments, adapter assembly 210 attaches to the engine or the engine housing 222 at a position that is at least partially rearward of the fuel tank 214. In some embodiments, adapter assembly 210 attaches to the engine or the engine housing 222 at a position that is entirely rearward of the fuel tank 214. In some embodiments, adapter assembly 210 attaches to the engine or the engine housing 222 at a position that is at least partially above the engine. Adapter assembly 210 may in some embodiments attach to a rail 218 of the walk-behind lawnmower 200.

Adapter assembly 210 is configured to receive an engine start request from an input device (not shown), and cause the starting motor to start the engine. The input device may be at least one of a push-button start, a key start, a switch, or any other input device. The input device may be attached to the rail 218 of the walk-behind lawnmower 200. In some embodiments, the input device attaches to a handle (not shown) of the walk-behind lawnmower 200.

Guide rails 226 are configured to interface with a channel (not shown) in a battery (not shown). In some embodiments, guide rails 226 guide the battery to be connected properly to the adapter assembly 210. In some embodiments, guide rails 226 ensure that the battery does not disconnect during operation of the walk-behind lawnmower 200, or during operation of the engine. Guide rails 226 may be configured to ensures that terminals of the battery connect properly to terminals 164 of the adapter assembly 210. In some embodiments, guide rails 225 are vertically oriented. In some embodiments, guide rails 225 are horizontally oriented. In some embodiments, guide rails 225 are oriented in neither a horizontal nor vertical orientation such that they angle downwards towards the engine 110.

Terminals 164 of the adapter assembly 210 may include a positive and a negative terminal. In some embodiments, terminals 164 include an enabler terminal. Terminals 164 are configured to interface with and connect to at least one of the terminals of the battery.

Adapter assembly 210 may also include a latch mechanism (not shown) to ensure that the battery does not disconnect from the adapter assembly 210 during operation of the engine or the walk-behind lawnmower 200. Adapter assembly 210 may be connected at a position entirely outside the engine housing 222, or it may be connected at a position partially inside of the engine housing 222.

The construction and arrangements of the adapter assembly, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that certain passages of this disclosure can reference terms such as “first” and “second” in connection with side and end, etc., for purposes of identifying or differentiating one from another or from others. These terms are not intended to merely relate entities (e.g., a first side and a second side) temporally or according to a sequence, although in some cases, these entities can include such a relationship. Nor do these terms limit the number of possible entities (e.g., sides or ends) that can operate within a system or environment.

The terms “coupled” and “connected” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

What is claimed is:

1. A battery adapter assembly for engine-powered outdoor power equipment, the battery adapter assembly comprising:
a battery pack comprising a plurality of battery cells, a positive terminal, and a negative terminal, wherein the battery pack is removable and replaceable;
an adapter configured to selectively connect to the battery pack and electrically connect to the positive terminal and the negative terminal of the battery pack;
a receiver configured to selectively receive and electrically connect to the adapter to transfer power from the battery pack to the receiver; and
a starting motor configured to start an internal combustion engine, the starting motor selectively receiving power supplied by the battery pack;
wherein the adapter is configured to connect to and transfer power from a plurality of battery packs having different voltages.

2. The battery adapter assembly of claim 1, wherein the battery pack is positioned rearward of the internal combustion engine and the battery pack selectively connects to at least one of a plurality of vertically oriented receiving rails of the adapter such that the battery pack couples to the adapter in a vertical orientation.

3. The battery adapter assembly of claim 1, wherein the battery comprises at least one of a 12 volt battery, a 14.4 volt battery, an 18 volt battery, a 20 volt battery, and a 24 volt battery.

4. The battery adapter assembly of claim 1, wherein the starting motor comprises at least one of a 12 volt starting motor and an 18 volt starting motor configured to start the internal combustion engine.

5. The battery adapter assembly of claim 1, wherein the adapter further comprises a processing circuit configured to output a voltage to the receiver and the starting motor, wherein the adapter is configured to:
output an increased voltage equal to a required voltage of the starting motor if the battery voltage is less than the required voltage of the starting motor; and
output a decreased voltage equal to the required voltage of the starting motor if the battery voltage is more than the required voltage of the starting motor.

6. The battery adapter assembly of claim 5, wherein the processing circuit is configured to use pulse width modulation to increase or decrease the output voltage to equal the required voltage of the starting motor.

7. The battery adapter assembly of claim 1, wherein the adapter is configured to connect to each battery in a set of batteries, each battery having different connection interfaces.

8. The battery adapter assembly of claim 1, wherein the adapter and the receiver are integrally formed.

9. The battery adapter assembly of claim 1, wherein the adapter further comprises a selecting device configured to select between a pre-determined set of batteries, wherein the selecting device adjusts an operation of the processing circuit based on the selection.

10. An air-cooled engine system for outdoor power equipment, the air-cooled engine system comprising:
an air-cooled engine comprising a piston reciprocating along a piston axis within a cylinder and configured to power an implement of the outdoor power equipment; and
a starting system configured to start the air-cooled engine, wherein the starting system comprises:
a battery pack having a plurality of battery cells each positioned along a battery cell axis;
an adapter configured to selectively connect to the battery pack and electrically connect to the positive terminal and the negative terminal of the battery pack;
a receiver configured to selectively receive and electrically connect to the adapter to transfer power from the battery pack to the receiver; and
a starting motor configured to start an internal combustion engine, the starting motor selectively receiving power supplied by the battery pack;
wherein the adapter is configured to connect to a variety of battery packs with different connection and attaching interfaces and output a voltage to the receiver;
wherein the receiver receives the voltage from the adapter and outputs the voltage to the starting motor.

11. The air-cooled engine system of claim 10, wherein the battery pack couples to the adapter in an orientation such that the battery cell axis is not parallel with the piston axis.

12. The air-cooled engine system of claim 10, wherein the battery pack comprises at least one of a 12 volt battery pack, a 14.4 volt battery pack, an 18 volt battery pack, a 20 volt battery pack, and a 24 volt battery pack.

13. The air-cooled engine system of claim 10, wherein the adapter and the receiver are integrally formed.

14. The air-cooled engine system of claim 10, wherein the adapter comprises a plurality of receiving rails configured to receive respective rails on the battery pack, the adapter oriented such that the plurality of receiving rails of the adapter are horizontal.

15. The air-cooled engine system of claim 10, wherein the adapter comprises a processing circuit configured to increase or decrease the voltage output to the receiver supplied by the battery pack using pulse width modulation, wherein the processing circuit is configured to:
increase the voltage output to the receiver to match a required voltage of the starting motor if the voltage of the battery pack is less than the required voltage of the starting motor; and
decrease the voltage output to the receiver to match the required voltage of the starting motor if the voltage of the battery pack is greater than the required voltage of the starting motor.

16. The air-cooled engine system of claim 15, wherein the processing circuit is further configured to output information regarding an operation of at least one of the adapter, the battery pack, and the starting motor to a user interface.

17. The air-cooled engine system of claim 15, wherein the adapter further comprises a circuit breaker configured to break when a current output from the adapter exceeds a threshold value, wherein the threshold value is determined by a specification at least one of the battery pack, the adapter, the receiver, and the starting motor.

18. A starting system for an outdoor power equipment, the starting system comprising:
a starting motor configured to supply mechanical energy to an engine to start the engine;
a receiver electrically connected to the starting motor configured to selectively attach to and electrically connect to an adapter; and
wherein the adapter is configured to selectively couple to and electrically connect to the receiver and a removable battery pack, wherein the battery pack is at least one of a 12 volt, 14.4 volt, 18 volt, 20 volt, and 24 volt battery pack, and wherein the adapter is configured to selectively couple to and electrically connect to a variety of battery connection types.

19. The starting system of claim 18, wherein the adapter further comprises a processing circuit configured to increase or decrease an output voltage to the receiver, wherein the processing circuit is configured to increase the output voltage to the receiver if a voltage of the battery is below a required voltage of the starting motor, and decrease the output voltage to the receiver if the voltage of the battery pack is above the required voltage of the starting motor.

20. The starting system of claim 19, wherein the processing circuit uses pulse width modulation to increase or decrease the output voltage.
